(19) United States
(12) Patent Application Publication
(10) Pub. No.: US 2026/0008980 A1
(43) Pub. Date: Jan. 8, 2026

(54) GRANULAR LAUNDRY DETERGENT COMPOSITION

(71) Applicant: THE PROCTER & GAMBLE COMPANY, Cincinnati, OH (US)

(72) Inventors: Linsey Sarah FULLER, Newcastle upon Tyne (GB); Lindsey HEATHCOTE, Northumberland (GB); Eva TRUSILEVIC, Newcastle upon Tyne (GB)

(21) Appl. No.: 19/257,671

(22) Filed: Jul. 2, 2025

(30) Foreign Application Priority Data
Jul. 5, 2024 (EP) 24186791.0

(51) Int. Cl. C11D 17/06; C11D 1/00; C11D 1/22; C11D 1/831; C11D 3/04; C11D 3/08; C11D 3/10; C11D 3/22; C11D 3/32; C11D 3/33; C11D 3/36; C11D 3/386; C11D 3/42; C11D 3/50

(52) U.S. Cl. CPC C11D 17/065; C11D 1/008; C11D 1/22; C11D 1/831; C11D 3/042; C11D 3/08; C11D 3/10; C11D 3/225; C11D 3/32; C11D 3/33; C11D 3/361; C11D 3/38609; C11D 3/42; C11D 3/505; C11D 2111/12; C11D 2111/44

(57) ABSTRACT

A granular laundry detergent composition, wherein the laundry detergent composition is present at a weight of between about 15 g and about 45 g; wherein, the laundry detergent composition includes; a first plurality of particles, wherein the particles within the first plurality of particles each have a bulk density of between about 1101 g/L and about 3000 g/L; a second plurality of particles, wherein the particles within the second plurality of particles each have a bulk density of between about 400 g/L and about 1100 g/L; wherein the laundry detergent composition includes about 10% or less by weight of the laundry detergent composition of the first plurality of particles and wherein the laundry detergent composition includes at least about 90% by weight of the laundry detergent composition of the second plurality of particles; and
wherein the laundry detergent composition is free flowing.

### FIELD OF THE INVENTION

The present invention is to a granular laundry detergent composition and method of use.

### BACKGROUND OF THE INVENTION

Laundry granular detergent compositions are known and used by consumers in laundry washing operations. Such compositions are free flowing granular detergents which are dosed by the consumer by using a suitable dosing device.

Without wishing to be bound by theory, such granular detergent compositions contain a plurality of different particles, said particles comprising the various ingredients/technologies of the detergent composition.

In order to ensure the consumer gets the performance they expect from their laundry granular detergent composition, it requires an efficient dose of the composition into the wash operation. Under-dosing can result in under-performance and over-dosing can result in wasted product. In addition, it is important that each dose contains the correct ratio of different technologies present within the composition to enable effective performance.

Traditionally, there has been a belief that to ensure the accuracy of dose and correct ratio of ingredients per dose, a larger dose volume is more effective. In other words, if the volume of the dose is too small, the consumer cannot dose accurately, even if a suitable dosing device is provided to ensure accurate measurement. In addition, it was believed that moving to smaller doses would mean a higher risk of not getting the correct ratio of ingredients per dose. Without wishing to be bound by theory, commonly granular laundry detergents are dosed at between 65 g and 220 g per laundry wash operation.

It was surprisingly found that by making the dose of granular laundry detergent composition smaller, accuracy of dosing was improved whilst still correct ratio of ingredients per dose was maintained.

### SUMMARY OF THE INVENTION

A first aspect of the present invention is a granular laundry detergent composition, wherein the laundry detergent composition is present at a weight of between 15 g and 45 g or even between 20 g and 40 g; wherein,
the laundry detergent composition comprises;
a first plurality of particles, wherein the particles within the first plurality of particles each have a bulk density of between 1101 g/L and 3000 g/L;
a second plurality of particles, wherein the particles within the second plurality of particles each have a bulk density of between 400 g/L and 1100 g/L;
wherein the laundry detergent composition comprises 10% or less by weight of the laundry detergent composition of the first plurality of particles and wherein the laundry detergent composition comprises at least 90% by weight of the laundry detergent composition of the second plurality of particles; and
wherein the laundry detergent composition is free flowing.

A second aspect of the present invention is a process of laundering a fabric, said process comprising the steps of;
a. obtain fabrics to be laundered;
b. obtain the granular laundry detergent composition according to any preceding claims;
c. obtain a suitable dosing device;
d. create a wash liquor by dosing between 15 g and 45 g or even between 20 g and 40 g, preferably between 25 g and 35 g, of said laundry detergent composition using said dosing device and mixing with water, preferably wherein the granular laundry detergent composition is dosed from a larger container;
   wherein the wash liquor is contacted with fabrics following formation of the wash liquor in step d, or the wash liquor is created in step d whilst in contact with the fabrics.

### DETAILED DESCRIPTION OF THE INVENTION

### Granular Laundry Detergent Composition

The present invention is a to a granular laundry detergent composition. The granular laundry detergent composition should be understood to be a free-flowing particulate composition. Typically, the granular laundry detergent composition is a fully formulated laundry detergent composition, not a portion thereof such as a spray-dried, extruded or agglomerate particle that only forms part of the laundry detergent composition.

The granular laundry detergent composition is present at a weight of between 20 g and 40 g. Without wishing to be bound by theory, it is this weight of the granular laundry detergent composition that is mixed with water to create a wash liquor. Fabrics to be cleaning are contacted with said wash liquor and an automatic wash process, a manual wash process of a semi-automatic wash process (involving both automatic and manual steps) is conducted in order to clean the fabrics. The granular laundry detergent composition may be contained in any suitable package. The package may be plastic, fibre-based or a mixture thereof. Fibre-based package may comprise paperboard, corrugated board or a mixture thereof. Where the package comprises both plastic and fibre-based materials, preferably, the package comprises less than 10% by weight, or even less than 5% by weight of the package of fibre-based material. Such a ratio of plastic to fibre-based materials is preferred as such low plastic content allows the package to be placed in paper recycling streams within many countries.

The granular laundry detergent composition may be present at a weight of between 15 g and 45 g or between 20 g and 40 g in the package with the intention that the total amount of the granular laundry detergent composition in the package is contacted with water to create the wash liquor. Alternatively, and more typically, the package contains a larger total weight of granular detergent composition with the intention that a weight of between 15 g and 45 g or even between 20 g and 40 g is measured from the larger quantity of granular detergent composition and contacted with water to create the wash liquor. Those skilled in the art will be aware of suitable devices to dose the granular laundry detergent composition. The dosing device may be made of plastic, fibre-based materials or a mixture thereof. The dosing device may comprise a handle or may have no handle. The dosing device may comprise visible and/or tactile lines to indicate appropriate dosing level to achieve the appropriate weight of granular laundry detergent composition. The dosing device may comprise a single visible and/or tactile line or may comprise multiple allowing dosing of different levels for different applications. The dosing device may be supplied with the packaged granular laundry detergent composition or may be supplied separately. Preferably, the packaging and the dosing device are recyclable using established recycling routes and infrastructure.

Where the package contains a larger total weight of granular detergent composition with the intention that a weight of between 15 g and 45 g or between 20 g and 40 g is measured from the larger quantity of granular detergent composition and contacted with water to create the wash liquor, the package may comprise at least 100 g, or even at least 200 g, or even at least 500 g, or even at least 1000 g, or even at least 2000 g of the granular detergent composition.

Typically, the granular laundry detergent composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions can comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0 g NaOH/100 g. These low buffered laundry detergent compositions typically comprise low levels of carbonate salt. The laundry detergent composition may have a pH of between 8 and 11 as measured by a 10% solution at 25° C. in deionised water.

The laundry detergent composition comprises a first plurality of particles, wherein the particles within the first plurality of particles each have a bulk density of between 1101 g/L and 3000 g/L or even between 1150 g/L and 2140 g/L. Without wishing to be bound by theory, it should be understood that every individual particle within the plurality of first particles has a bulk density of between 1101 g/L and 3000 g/L or even between 1150 g/L and 2140 g/L. The particles within the first plurality may be agglomerates, drum dried flakes, extrudates, beads or a mixture thereof. Those skilled in the art will be aware of known processes for making the particles. Those skilled in the art will be aware of suitable methods to measure the bulk density. Without wishing to be bound by theory, bulk density is calculated by measuring the mass of a known volume of granules. The bulk density of the material is calculated using the following formula: D=M/V, where: D: Bulk density (g/1) M: Weight of the full container (g) V: Container volume (1).

A publicly available method for measuring bulk density is available as ISO 60:2023.

A preferred method of measuring bulk density uses a passing a sample of laundry detergent to be measured through a funnel into a receiving cup. Weigh the clean empty cup to the nearest 0.1 g (W1g) and place the tared cup under the funnel. Close the funnel at the bottom opening. Fill the funnel with the sample and then open the closure, allowing the sample to run into and overflow the cup. Carefully level the contents of the cup with the straight edge, and then tap gently to compact the powder. Weigh the cup with sample to the nearest 0.1 g (W2g).

Weigh the cup with sample to the nearest 0.1 g (W2g). Apparent Bulk−Repour Cup Density (grams/Litre)=2*(weight of powder in cup)=2(W2−W1) g/L.

The particles within the first plurality of particles may have any suitable chemistry providing they each individually have the necessary bulk density. The particles in the first plurality may comprise a first ingredient, wherein the first ingredient comprises a source of alkalinity, preferably an alkali metal salt or an alkaline Earth metal salt, preferably the source of alkalinity is selected from sulphate salts, carbonate salts, sodium chloride, or a mixture thereof. Suitable sulphate salts including sodium sulphate, magnesium sulphate or a mixture thereof. Suitable carbonate salts include sodium carbonate, magnesium carbonate or a mixture thereof.

The laundry detergent composition comprises a second plurality of particles, wherein the particles within the second plurality of particles each have a bulk density of between 400 g/L and 1100 g/L or even between 450 g/L and 1054 g/L. Without wishing to be bound by theory, it should be understood that every individual particle within the plurality of first particles has a bulk density of between 400 g/L and 1100 g/L or even between 450 g/L and 1054 g/L. The particles within the second plurality may be spray dried particles, drum dried flakes, agglomerates or a mixture thereof, optionally wherein the second plurality of particles have been through a milling or griding step to reduce the particle size. Those skilled in the art will be aware of suitable milling processes and apparatus. Suitable milling could be conducted via Ball mills, barrel mill, crushers, grinding, hammer mill, jet milling, roller compactors, air classifying mills, classifier mill, granulation, impact mill, micronisation or a mixture thereof. Those skilled in the art will be aware of known processes for making the particles. Those skilled in the art will be aware of suitable methods to measure the bulk density. Bulk density is described above.

The particles within the second plurality of particles may have any suitable chemistry providing they each individually have the necessary bulk density. The particles of the second plurality may comprise a second ingredient, wherein the second ingredient comprises surfactants, hueing dyes, enzymes, polymers, brightener, chelant, bleach, bleach activator, anti-foam agent, perfume particles or a mixture thereof. These ingredients are described in more detail below.

The laundry detergent composition comprises 10% or less by weight of the laundry detergent composition of the first plurality of particles and the laundry detergent composition comprises at least 90% by weight of the laundry detergent composition of the second plurality of particles.

The laundry detergent composition may comprise an anionic surfactant, preferably, wherein the anionic surfactant is present between 5% and 30%, preferably wherein the anionic surfactant comprises linear alkylbenzene sulphonate, alky sulphate, ethoxylated alkyl sulphate, methyl ester sulphonate, rhamnolipid surfactants or a mixture thereof.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

The laundry detergent composition comprises a non-ionic surfactant, preferably between 1% and 30% by weight of the granular detergent composition of the non-ionic surfactant, more preferably, wherein the non-ionic surfactant is a fatty alcohol ethoxylate, most preferably a fatty alcohol ethoxylate having an average carbon chain length of between 11 and 18 and an average degree of ethoxylation of between 5 and 25.

The non-ionic surfactant may be a fatty alcohol ethoxylate, preferably, wherein the granular laundry detergent composition comprises between 0.1% and 40% by weight of the granular laundry detergent composition of the fatty alcohol ethoxylate. The non-ionic surfactant may be a non-ionic deterseive surfactant. Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈-₁₈ alkyl alkoxylated alcohol, preferably a C₈-₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈-₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

The hueing dye may be selected from direct violet 9, direct violet 66, direct violet 99, acid violet 50, solvent violet 13, or a combination thereof. The granular laundry detergent composition may comprise between 0.1% and 10% by weight of the granular laundry detergent composition of the hueing dye.

The hueing dye may have the following structure;

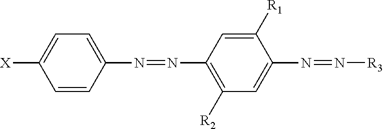

wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

The hueing dye may have the following structure:

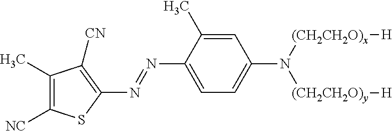

wherein the index values x and y are independently selected from 1 to 10.

Suitable polymers include carboxylate polymers, soil release polymers, anti-redeposition polymers, cellulosic polymers, care polymers and any combination thereof.

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst. Suitable sources of hydrogen peroxide include sodium perborate and/or sodium percarbonate. Suitable bleach activators include tetra acetyl ethylene diamine and/or alkyl oxybenzene sulphonate. The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

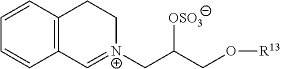

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Suitable pre-form peracids include phthalimido-peroxycaproic acid.

Preferably, the composition comprises an imine-based bleach catalyst and/or an iminium-based bleach catalyst. Suitable bleach catalysts include WeylClean CC from Weylchem (3-methyl-1,2-benzisothiazol-1,1-dioxide).

Suitable enzymes include lipases, proteases, cellulases, amylases and any combination thereof.

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN. Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)];amino} stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

The composition may comprise a chelant. Suitable chelants may include: DTPA (diethylenetriaminepentaacetic acid), HEDP (hydroxyethanediphosphonic acid), EDDS (ethylenediamine disuccinate (EDDS), DTPMP (diethylene triamine penta (methylene phosphonic acid)), EDTMP (ethylene diamine tetra (methylene phosphonic acid)), Tiron® (1,2-diydroxybenzene-3,5-disulfonic acid), HPNO (2-pyridinol-N-oxide), MGDA (methylglycinediacetic acid), GLDA (glutamic-N,N-diacetic acid), IDS (iminodisuccinic acid) chelant, any suitable derivative thereof, salts thereof, and mixtures thereof.

The composition may comprise chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (c) mixtures thereof. It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

The laundry detergent composition may comprise less than 15wt %, or even less than 10wt %, or even less than 5wt %, or even less than 2wt %, or even less than 1wt %, or even less than 0.5wt % of filler material, preferably wherein the filler material is selected from alkali metal carbonates, alkali metal sulphonates, clays, zeolites, silicates, sodium chloride or a mixture thereof. Without wishing to be bound by theory, low levels of filler material allow for more compacted or concentrated formulations and hence lower dosages needed during the wash operation.

### Process of Laundering a Fabric

The present invention also contemplates a process of laundering a fabric, said process comprising the steps of;
a. obtain fabrics to be laundered;
b. obtain the granular laundry detergent composition according to the present invention;
c. obtain a suitable dosing device;
d. create a wash liquor by dosing between 15 g and 45 g or even between 20 g and 40 g, preferably between 25 g and 35 g, of said laundry detergent composition using said dosing device and mixing with water, preferably wherein the granular laundry detergent composition is dosed from a larger container;
wherein the wash liquor is contacted with fabrics following formation of the wash liquor in step d, or the wash liquor is created in step d whilst in contact with the fabrics.

Any suitable fabric may be used. Suitable fabrics include synthetic materials, natural materials or a mixture thereof. Preferably between 1 kg and 10 kg, or even between 1 kg and 8 kg of fabrics are used in the process. The fabrics can be the same or similar colours, or can be a range of different colours.

The fabrics may be washed at a temperature of between 15° C. and 50° C., preferably between 15° C. and 30° C.

Other laundry additives, such as fabric softeners or freshness additives may also be added to the fabrics. Such additives may be added at the same time or a different time to the granular laundry detergent composition.

The process may be a manual one, an automated one or a mixture thereof.

The process may take between 15 mins and 4.5 hours, or even between 15 mins and 2.5 hours, or even between 15 mins and 1.5 hours to complete.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

### Dose Accuracy

Two powder detergent compositions (Compositions 1 & 2) were made and tested as detailed herein below. The tests investigated whether the consumer can accurately dose a small volume, and whether moving to smaller doses would mean a higher risk of not getting the correct ratio of ingredients per dose.

### Test Method

### Preparation of Test Compositions

Tests were carried out using the following detergent compositions: Material additions shown at active material level in finished product (FP). Composition 1 was designed to require 60 g to be used in a wash operation, whereas composition 2 was designed to require 30 g to be used in a wash operation. When used at these dosages, both compositions would result in the same cleaning performance.

| | | Composi- | Composi- |
|---|---|---|---|
| | bulk | tion 1 | tion 2 |
| | density | % | % |
| Linear sodium alkylbenzene | 500 | 10.967 | 11.500 |
| sulphonate | | | |
| NI C24 C₁₂₋₁₄ EO7 non-ionic | 1050 | 1.950 | 4.095 |
| surfactant | | | |
| Acrylic/maleic copolymer | 601 | 1.317 | 2.761 |
| Amphiphilic graft copolymer | 677 | 0.117 | 0.241 |
| carboxymethylcellulose | 509 | 0.267 | 0.556 |
| Na2CO3 | 1054 | 8.450 | 17.74 |
| Silicate | 1000 | 5.217 | 10.95 |
| Sodium sulphate | 1476 | 46.883 | 0.000 |
| Granular Sodium Percarbonate (AvOx | 1050 | 17.117 | 35.940 |
| 13.1) | | | |
| TAED | 1000 | 4.333 | 9.103 |
| MGDA U1G (BASF) | 1000 | 0.550 | 1.155 |
| HEDP | 741 | 0.350 | 0.735 |
| Hueing dye | 2140 | 0.767 | 1.606 |
| diaminostilbene brightener | 750 | 0.033 | 0.073 |
| distyrylbiphenyl brightener | 750 | 0.100 | 0.210 |
| Protease | 2140 | 0.333 | 0.703 |
| Amylase | 2140 | 0.150 | 0.315 |
| Sixin G20XV (Dow) | 700 | 0.150 | 0.315 |
| Perfume | 1000 | 0.600 | 1.260 |
| Starch based perfume carrier. | 450 | 0.350 | 0.735 |
| Total | | 100.000 | 100.000 |

### Test Procedures

### Variability

| | | |
|---|---|---|
| Detergent quantity | | 2.4 kg Composition 1 |
| | | 1.2 kg Composition 2 |
| Particle sampling | Rotary sampler | 10-pot Pascal cone sampler |
| Sampled product weighing | Balance | 4 dp Ohaus balance |
| Maceration | Coffee grinder | |

All materials were added to a metal Kenwood mixer bowl following the detergent compositions above. Once all materials were added, the mixture was passed through a 10-pot Pascal cone sampler 3 times at speed setting 20. The total weight of 600 g (for Composition 1) and 300 g (for Composition 2) were weighed and fed through a 10-pot Pascal cone sampler at speed setting 20 before being weighed in individual plastic pots. Finished products were ground using coffee grinder for 10 seconds to yield a homogenous mix. Macerated samples were stored in a 10 freezer prior analytical analysis.

### Dosage

| | | |
|---|---|---|
| Detergent addition | | 2.4 kg Composition 1 |
| | | 2.4 kg Composition 2 |
| Bulk product weighing | Balance | 4 dp Ohaus balance |
| Container | Detergent box | Cardboard detergent box |
| | | (18 cm × 9 cm × 21 cm) |
| Scoop | 3D printed | 60 g and 30 g |
| | dosage device | |
| Consumer scooped | Balance | 2 dp Precisa balance |
| product weight | | |

Individual raw material quantities were weighed on the balance before combining to make the bulk laundry composition. Bulk compositions were mixed to ensure they were homogenous before being decanted into containers by pouring.

### Methods to Analyze Active Variability

### Analysis of AVO:

Determination of AvO in finished products was completed using the following procedure. 20 g of macerated sample was weighed into an anti-static 5 L beaker. 50 mL of glacial acetic acid was added to the beaker and swirled to ensure all the product is coated with the acetic acid. 2 L of tap water was added to the beaker and stirred using Silverson stirrer for 5 minutes. 5 mL of the sample was filtered using a 5 ml syringe equipped with a 0.45 um syringe filter, filtrate was then placed in the Gallery Automated Chemistry Analyzer (Thermofisher Scientific). Solution samples were measured for hydrogen peroxide (H₂O₂) by colorimetric assay using Gallery Automated Chemistry Analyzer (Thermofisher Scientific) for reaction between the wash solution and Amplex Red reagent (CAS: 119171-73-2) in the presence of horseradish peroxidase (CAS: 9003-99-0). The measured species is resorufin which is created by reaction of Amplex Red reagent with hydrogen peroxide.

### Analysis of TAED:

Determination of TAED in finished products was completed using the following procedure. 20 g of macerated sample was weighed into an anti-static 5 L beaker. 2 L of tap water was added to the beaker and stirred using Silverson stirrer for 5 minutes. 5 mL of the sample was filtered using a 5 ml syringe equipped with a 0.45 um syringe filter, filtrate was then placed in the Gallery Automated Chemistry Analyzer (Thermofisher Scientific). TAED presence in solution samples was measured using Gallery Automated Chemistry Analyzer (Thermofisher Scientific) for reaction between the wash solution and 2,2-Azino-bis(3-ethylbenzothiazoline)-6-sulfonate (ABTS) (CAS: 30931-67-0) in the presence of potassium iodide (KI) (CAS: 7681-11-0). Measured species is ABTS″ radical formed by reaction of ABTS with PAA. This process is greatly accelerated in the presence of KI.

### Analysis of Scooping Data

Determination of scooping per consumer was completed by weighing every dose of product a consumer scooped on a balance. Consumers were asked to scoop the detergent naturally with the device provided or consumers were asked to scoop the detergent using the device provided without overfilling the scooping device. Every dose of composition 1 and 2 for every consumer was recorded as weight scooped in (g). Results were then analyzed to provide average/mean and median scoop weight per composition via:

$$MEAN or AVERAGE scoop weight = Total scoop weight for all consumers / number of consumers$$

$$Median scoop weight = Total scoop weight for all consumers / 2.$$

### Results:

Variability of key actives i.e. Enzymes & bleach. The standard deviation is shown for the averaged results in terms of amount of the target quantity of each ingredient per scoop.

| | | Amylase | Protease | AvO | TAED |
|---|---|---|---|---|---|
| composi- | Target | 0.02166 | 0.284 | 2.26 | 4.33 |
| tion 1 | SD | 0.001 | 0.0145 | 0.0394 | 0.1696 |
| composi- | Target | 0.04394 | 0.565 | 4.52 | 8.67 |
| tion 2 | SD | 0.0009 | 0.0206 | 0.0294 | 0.1129 |

The data show that there is no meaningful difference in the level of actives present meaning that both smaller and larger doses can be used to result in accurate level of ingredients per dose.

### Dose accuracy

In total 60 data points were collected for each product.
For the 30 g dose, the average dose had 13% deviation from target quantity.
For the 60 g dose, the average dose had a 21% deviation from target quantity.

The examples demonstrate the efficacy of Composition 2 to improve the accuracy of delivering key detergent actives on target and aiding consumers to dose the correct amount of product when directed with a scooping device.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A granular laundry detergent composition, wherein the laundry detergent composition is present at a weight of between about 15g and about 45g; wherein,
the laundry detergent composition comprises;
a first plurality of particles, wherein the particles within the first plurality of particles each have a bulk density of between about 1101g/L and about 3000g/L;
a second plurality of particles, wherein the particles within the second plurality of particles each have a bulk density of between about 400g/L and about 1100g/L;
wherein the laundry detergent composition comprises about 10% or less by weight of the laundry detergent composition of the first plurality of particles and wherein the laundry detergent composition comprises at least about 90% by weight of the laundry detergent composition of the second plurality of particles; and
wherein the laundry detergent composition is free flowing.

2. The laundry detergent composition according to claim 1 wherein the particles within the first plurality of particles each have a bulk density of between about 1150g/L and about 2140g/L.

3. The laundry detergent composition according to claim 1, wherein the particles within the second plurality of particles each have a bulk density of between about 450g/L and about 1054g/L.

4. The laundry detergent composition according to claim 1, wherein the particles in the first plurality are agglomerates, drum dried flakes, extrudates, beads or a mixture thereof.

5. The laundry detergent composition according to claim 1, wherein the particles in the second plurality are spray dried particles, drum dried flakes, agglomerates or a mixture thereof.

6. The laundry detergent composition according to claim 1, wherein the second plurality of particles have been through a milling or griding step to reduce the particle size.

7. The laundry detergent composition according to claim 1 wherein the particles in the first plurality comprise a first ingredient, wherein the first ingredient comprises a source of alkalinity.

8. The laundry detergent composition according to claim 7, wherein the source of alkalinity is an alkali metal salt or an alkaline Earth metal salt.

9. The laundry detergent composition according to claim 8, wherein the source of alkalinity is selected from sulphate salts, carbonate salts, sodium chloride, or a mixture thereof.

10. The laundry detergent composition according to claim 1 wherein the particles of the second plurality comprises a second ingredient, wherein the second ingredient comprises surfactants, hueing dyes, enzymes, polymers, brightener, chelant, bleach, bleach activator, anti-foam agent, perfume particles or a mixture thereof.

11. The laundry detergent composition according to claim 1, wherein the laundry detergent composition comprises an anionic surfactant.

12. The laundry detergent composition according to claim 1, wherein the laundry detergent composition comprises a non-ionic surfactant.

13. The laundry detergent composition according to claim 1, wherein the laundry detergent composition has a pH of about 8-11 as measured by 10% solution at 25° C. in deionised-water.

14. The laundry detergent composition according to claim 1, wherein the laundry detergent composition comprises less than about 15wt % of filler material.

15. The laundry detergent composition according to claim 14, wherein the filler material is selected from alkali metal carbonates, alkali metal sulphonates, clays, zeolites, silicates, sodium chloride or a mixture thereof.

16. A process of laundering a fabric, said process comprising the steps of;
a. obtain fabrics to be laundered;
b. obtain the granular laundry detergent composition according to claim 1;
c. obtain a suitable dosing device;
d. create a wash liquor by dosing between about 15g and about 45g of said laundry detergent composition using said dosing device and mixing with water;
wherein the wash liquor is contacted with fabrics following formation of the wash liquor in step d, or the wash liquor is created in step d whilst in contact with the fabrics.

17. The process according to claim 16, wherein the fabrics are washed at a temperature of between about 15° C. and about 50° C.

18. The process according to claim 17 wherein the process is a manual one, an automated one or a mixture thereof.

19. The process according to claim 17, wherein the process takes between 15 mins and 4.5 hours to complete.
